(19) United States
(12) Patent Application Publication
(10) Pub. No.: US 2005/0259610 A1
(43) Pub. Date: Nov. 24, 2005

(54) Wireless communications system including a target base station capable of notifying of channel resource reservation status

(75) Inventors: John K. Demers, Encinitas, CA (US); Mark Alan Schmitt, Charles Town, WV (US)

Correspondence Address: CROWELL & MORING LLP;INTELLECTUAL PROPERTY GROUP, P.O. BOX 14300, WASHINGTON, DC, 20044-4300, US

(73) Assignee: Nextel Communications, Inc.

(21) Appl. No.: 10/893,450

(22) Filed: Jul. 16, 2004

Related U.S. Application Data
(60) Provisional application No. 60/573,441, filed on May 21, 2004.

(51) Int. Cl. H04Q 7/00

(52) U.S. Cl. 370/328

(57) ABSTRACT

A wireless communications system including a network application server to transmit an expedited request packet; and a base station to receive the expedited request packet from the network application server, attempt to reserve channel resources for a traffic channel to communicate with the SU, and notify the network application server of whether the channel resources have been reserved. The base station may notify the network application server by transmitting the expedited request packet to the SU, receiving a response to the expedited request packet from the SU, marking the response to indicate whether the channel resources have been reserved, and sending the marked response to the network application server.

### CROSS REFERENCE TO RELATED APPLICATION

This application claims the benefit of the filing date of Provisional Patent Application Ser. No. 60/573,441, filed on May 21, 2004, entitled “Wireless Communications System Including a Base Station Capable of Notifying Channel Resource Reservation Status,” which is incorporated herein by reference.

### FIELD OF THE INVENTION

This invention relates generally to wireless communications systems, and in particular, to a wireless communications system including a target base station capable of notifying a network application server as to the status of the reservation of channel resources.

### BACKGROUND OF THE INVENTION

A typical wireless communications system includes a network application server, a plurality of base stations communicatively coupled to the network application server, and a plurality of subscriber units (SUs) that communicate with the network application server by way of the base stations. Generally, when the network application server needs to communicate with the SU, or vice-versa, the SU and the base station currently serving the SU establish a traffic channel through which communications are sent between the network application server and the SU. The process of establishing such a traffic channel, however, is more involved as discussed below.

Generally, an SU will from time-to-time enter into a “dormant mode,” i.e. a low power mode to conserve its internal-battery life. When not in the “dormant mode,” an SU maintains one or more traffic channels with the base station even if the subscriber is not using the device. In the “dormant mode,” however, an SU does not maintain any traffic channels with the base station. Instead, the SU only responds to subscriber initiated actions and periodically monitors the paging channel to determine whether it has been paged.

Typically, when the network application server needs to communicate with a “dormant” SU on an expedited basis, it sends an expedited application request data packet to the base station currently serving the SU. An example of such an expedited data packet is a request to communicate with the target SU. In response to the expedited data packet, the base station transmits a paging message to the SU by way of a paging channel. In response to receiving the paging message, the SU exits its “dormant mode,” transmits a paging message response to the base station by way of the paging channel, begins to monitor a common channel, and also attempts, in coordination with the base station, to establish a traffic channel through which communications are transmitted between the wireless communication system and the SU. The common channel is a data communication path shared by all SUs currently listening to the base station.

After the base station receives the paging message response, it transmits the expedited data packet to the SU by way of a short data burst transmitted via the common channel. In response to receiving the expedited data packet, the SU responds by transmitting a response to the expedited data packet to the base station by way of a short data burst transmitted via the common channel. For example, the response may be a specific response to the request to communicate, indicating that the SU is available to communicate with the calling entity. The base station subsequently sends the response to the expedited data packet to the network application server.

Once the network application server receives the response to the expedited data packet, it automatically assumes that channel resources for a traffic channel between the base station and the SU have been reserved. The network application server then operates as if such channel resources have been reserved, and allows communications to be sent to the base station for transmission to the SU by way of the reserved traffic channel.

However, there may be situations when the base station has yet to reserve channel resources for a traffic channel when the network application server receives the response to the expedited data packet. This may be because there are no available traffic channels at such time because they are being used by other subscribers. In such a case, the network application server operates as if such traffic channel has been reserved, and begins allowing data to be sent to the base station for subsequent transmission to the SU. This leads to a “false positive” situation where a calling entity is sending voice and/or data to the SU under the assumption that a traffic channel exists, when in fact it does not. And consequently, such voice and/or data communications may be lost.

### SUMMARY OF THE INVENTION

An aspect of the invention relates to a wireless communications system including a network application server to transmit an expedited request packet; and a base station to receive the expedited request packet from the network application server, attempt to reserve channel resources for a traffic channel to communicate with the SU, and notify the network application server of whether the channel resources have been reserved. An exemplary method of notifying the network application server of whether channel resources have been reserved includes the base station transmitting the expedited request packet to the SU, receiving a response to the expedited packet request from the SU, marking the response to indicate whether channel resources have been reserved, and sending the marked response to the network application server. The term “channel resources” as defined herein means any resource used to support the requested traffic channel including, but not limited to, network bandwidth, radio frequency (RF) bandwidth, Walsh codes, time slots, forward power resources, internal base station capacity parameters, etc.

Another aspect of the invention relates to a base station comprising a network interface; a radio frequency (RF) interface; and a processor to receive an expedited request packet from a network application server by way of the network interface, attempt to reserve channel resources for a traffic channel to communicate with the SU, and notify the network application server of whether the channel resources have been reserved. The base station may notify the network application server by transmitting the expedited request packet to the SU, receiving a response to the expedited request packet from the SU, marking the response to indicate whether channel resources have been reserved, and sending the marked response to the network application server. Also disclosed are a method and computer readable medium including one or more software modules related to the operations of the base station.

Yet another aspect of the invention relates to a network application server comprising a network interface; and a processor to transmit an expedited request packet to a base station by way of the network interface, and receive a notification from the base station as to whether a traffic channel to communicate with the SU have been reserved, wherein the notification is received by way of the network interface. The processor performs a predetermined operation based on what the notification indicates about the reservation of the channel resources. Also disclosed are a method and a computer readable medium storing one or more software modules related to the operations of the network application server.

Still another aspect of the invention relates to a subscriber unit, comprising an RF interface; and a processor to transmit a request to a wireless communications system by way of the RF interface, wherein the request identifies a target subscriber unit, and receive a notification by way of the RF interface indicating that channel resources for a traffic channel between the target subscriber unit and a target base station could not be reserved. Also disclosed are a method and a computer readable medium storing one or more software modules related to the operations of the subscriber unit.

Other aspects, features, and techniques of the invention will be apparent to one skilled in the relevant art in view of the following detailed description of the invention.

### BRIEF DESCRIPTION OF THE DRAWINGS

FIG. 1 illustrates a block diagram of an exemplary wireless communications system in accordance with an embodiment of the invention;

FIG. 2 illustrates a signal flow diagram illustrating exemplary signals generated in the exemplary wireless communications system in a channel resource reservation success scenario in accordance with another embodiment of the invention;

FIG. 3 illustrates a signal flow diagram illustrating exemplary signals generated in the exemplary wireless communications system in a channel resource reservation failure scenario in accordance with another embodiment of the invention;

FIG. 4A illustrates a block diagram of an exemplary base station in accordance with another embodiment of the invention;

FIG. 4B illustrates a flow diagram of an exemplary method implemented by the exemplary base station in accordance with another embodiment of the invention;

FIG. 5A illustrates a block diagram of an exemplary network application server in accordance with an embodiment of the invention;

FIG. 5B illustrates a flow diagram of an exemplary method implemented by the exemplary network application server in accordance with another embodiment of the invention;

FIG. 6 illustrates a diagram of an exemplary packet header in accordance with another embodiment of the invention;

FIG. 7A illustrates a block diagram of an exemplary subscriber unit in accordance with another embodiment of the invention; and

FIG. 7B illustrates a flow diagram of an exemplary method implement by the subscriber unit in accordance with another embodiment of the invention.

### DETAILED DESCRIPTION OF THE EXEMPLARY EMBODIMENTS

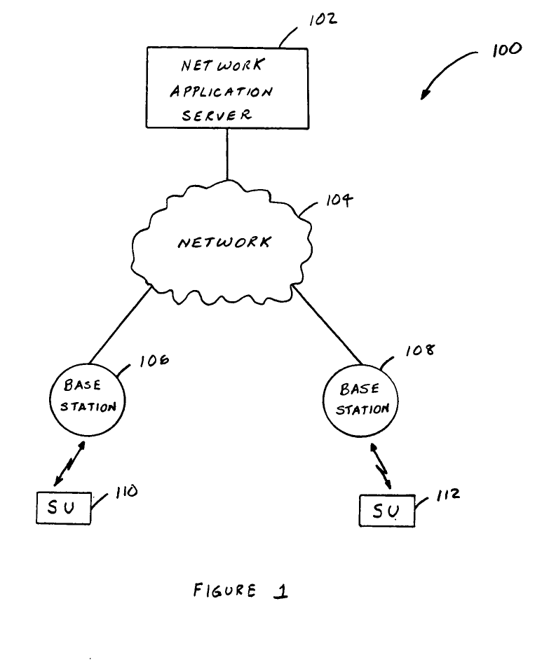

FIG. 1 illustrates a block diagram of an exemplary wireless communications system 100 in accordance with an embodiment of the invention. The wireless communications system 100 comprises a network application server 102, a network 104, and a plurality of base stations 106 and 108 (two of which are shown). The wireless communications system 100 serve a plurality of subscriber units (SUs) 110 and 112. As later discussed in more detail, the base stations 106 and 108 are configured to mark a response sent from an SU to the network application server 102 to indicate whether channel resources have been reserved for the purpose of sending communications to the SU. The term “communications” as used herein include voice, data, control signals, and other information.

The network application server 102 handles requests to setup communications channels between a plurality of communicating devices such as SUs, data servers, other application servers, etc. For example, the network application server 102 may be a dispatch call processing unit to setup communications channels to facilitate dispatch (walkie-talkie type) communications between a plurality of communicating devices. Alternatively, or in addition to, the network application server 102 may be an instant message processing unit to setup communications channels to facilitate instant message communications between a plurality of communicating devices. Alternatively, or in addition to, the network application server 102 may be a database processing unit to setup communications channels to facilitate database communications between a plurality of communicating devices. Alternatively, or in addition to, the network application server 102 may be a global positioning satellite (GPS) processing unit to setup communications channels to facilitate location information communications between a plurality of communicating devices. The network application server 102 may be capable of handling other types of communication applications.

The network 104 serves to facilitate communications between the network application server 102 and the base stations 106 and 108. The network 104 may be of any suitable types, including without limitations Internet Protocol (IP), asynchronous transfer mode (ATM), and frame relay.

The base stations 106 and 108 provide a wireless (i.e., radio frequency (RF)) interface between the SUs 110 and 112 and the network 104. The base station 106 and 108 may use any suitable RF protocol for communicating with the SUs 106 and 108. For example, suitable RF protocols include code division multiple access (CDMA), wideband CDMA (WCDMA), frequency division multiplexing (FDM), orthogonal FDM (OFDM), time division multiple access (TDMA), or any combination thereof.

The SUs 110 and 112 may be any mobile and/or stationary device that subscribers use to communicate with the wireless communications system 100. For example, subscriber units 110 and 112 may include handsets, laptop computers, personal digital assistants (PDAs), desktop computers, global positioning satellite (GPS) devices, game devices, etc.

As the various elements of the wireless communications system 100 have been addressed, the following describes an exemplary method, implemented by a base station, to notify the network application server as to the status of the reservation of channel resources. In this example, the SU 110 intends to make a dispatch call to SU 112, which is in a “dormant mode.”

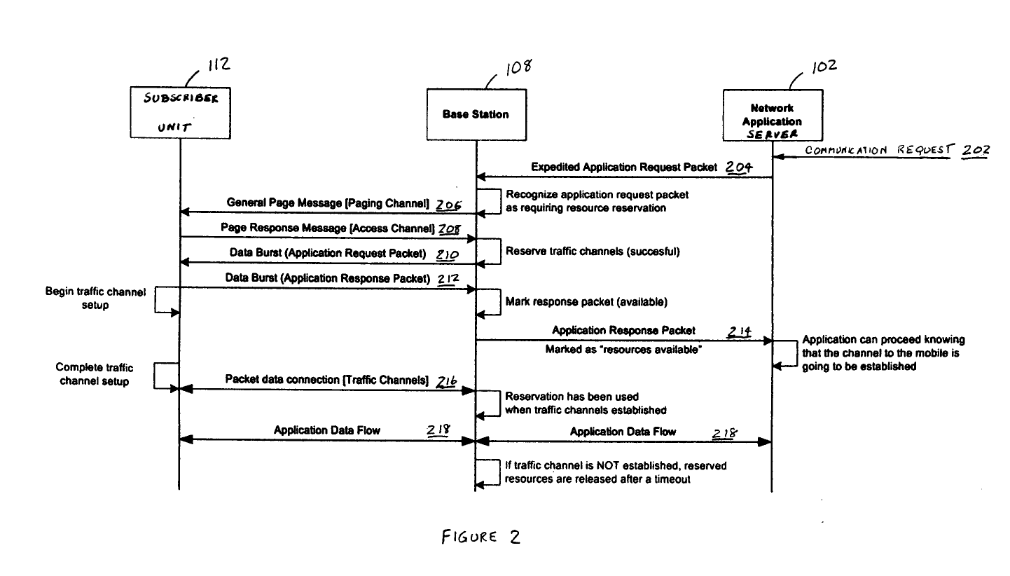

With reference to both FIGS. 1-2, in which the latter illustrates a signal diagram associated with the exemplary method of notifying a network application server as to the success of the base station in reserving channel resources, the network application server 102 first receives a communication request 202, such as a dispatch call request, from SU 110 by way of base station 106 and the network 104. The communication request 202 identifies SU 112 as the target for the communication.

In response to receiving the communication request 202, the network application server 102 sends an expedited application request packet 204 to the base station 108 by way of the network 104. The expedited application request packet 204 is marked for transmission by the base station 108 to the SU 112 in an expedited manner, i.e., before a traffic channel is setup between the base station 108 and the SU 112. For example, the expedited application request packet 204 may be sent by the base station 108 to the SU 112 using a short data burst communicated by way of a common channel. The expedited application request packet 204 may further include information as to the type of communication requested, such as dispatch, and the initiator of the communication, such as SU 110. The expedited application request packet 204 also informs the base station 108 that it is required to reserve channel resources for handling the requested communication.

In response to receiving the expedited application request packet 204, the base station 108 sends a general paging message 206 to the SU 112 using a paging channel. The general paging message 206 causes the SU 112 to become active (i.e., exit its “dormant mode”) and listen to the common channel for incoming communications. Once the SU 112 becomes active, it sends a response 208 to the general paging message to the base station 108 using the paging channel. Once the base station 108 receives the response 208, it attempts to reserve channel resources for a traffic channel between the base station 108 and the SU 112 for the requested communication. In this example, the reservation of such channel resources is a success.

After receiving the response 208, the base station 108 transmits a short data burst 210 including the information contained in the expedited application request packet 204 to the SU 112 by way of the common channel. This informs the SU 112 of the type of communication requested (e.g. a dispatch communication) and the initiator of the communication (e.g. SU 110). In response to receiving the short data burst 210, the SU 112 sends a short data burst 212 containing a response to the received expedited application request packet to the base station 108 using the common channel. The response 212 may indicate that the SU 112 is available for the requested communication.

Since in this example, the base station 108 has successfully reserved channel resources for a traffic channel to handle the requested communication, upon receiving the response 212 to the expedited application request packet, the base station 108 marks the response to indicate that channel resources have been reserved. The base station 108 then sends the marked response 214 to the expedited application request packet to the network application server 102 by way of the network 104. In this case, the network application server 102 knows that channel resources for a traffic channel between the base station 108 and the SU 112 has been reserved. Accordingly, the network application server 102 proceeds to facilitate the requested communication 218 by way of the established traffic channel. The above example illustrates the case where the base station has successfully reserved channel resources for a traffic channel. The following example illustrate the case where the base station is not successful in reserving channel resources for a traffic channel.

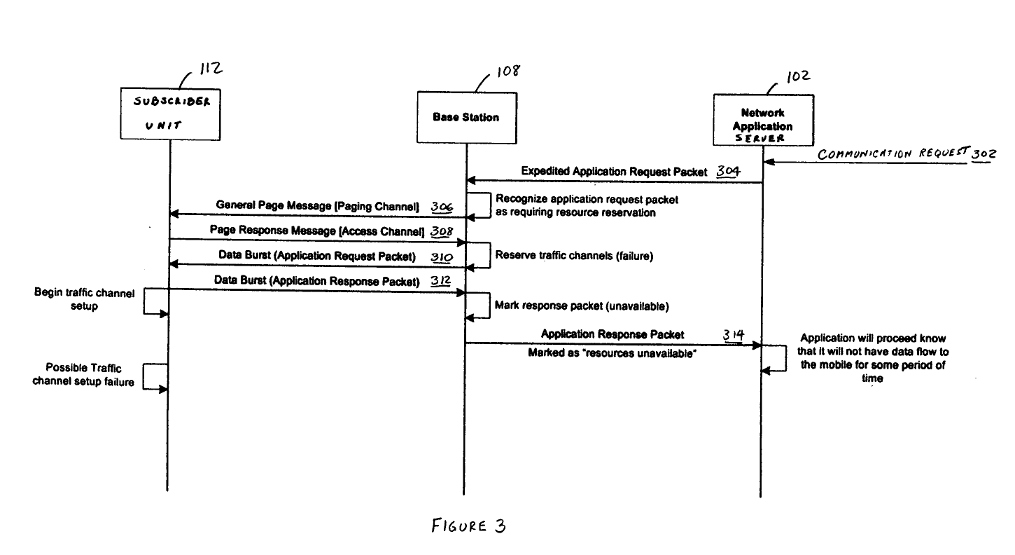

With reference to both FIGS. 1 and 3, in which the latter illustrates a signal diagram associated with the exemplary method of notifying a network application server as to the failure of the base station 108 to reserve channel resources for a traffic channel, the network application server 102 first receives a communication request 302, such as a dispatch call request, from SU 110 by way of base station 106 and the network 104. The communication request 302 identifies SU 112 as the target for the communication.

In response to receiving the communication request 302, the network application server 102 sends an expedited application request packet 304 to the base station 108 by way of the network 104. The expedited application request packet 304 is marked for transmission by the base station 108 to the SU 112 in an expedited manner, i.e., before a specific traffic channel is setup between the base station 108 and the SU 112. For example, the expedited application request packet 304 may be sent by the base station 108 to the SU 112 using a short data burst communicated by way of a common channel. The expedited application request packet 304 may further include information as to the type of communication requested, such as dispatch, and the initiator of the communication, such as SU 110. The expedited application request packet 304 also informs the base station 108 that it is required to reserve channel resources for a traffic channel for handling the requested communication.

In response to receiving the expedited application request packet 304, the base station 108 sends a general paging message 306 to the SU 112 using a paging channel. The general paging message 306 causes the SU 112 to become active (i.e., exit its “dormant mode”) and listen to the common channel for incoming communications. Once the SU 112 becomes active, it sends a response 308 to the general paging message to the base station 108 using the paging channel. Once the base station 108 receives the response 308, it attempts to reserve channel resources for a traffic channel between the base station 108 and the SU 112 for the requested communication. In this example, the reservation of the channel resources is not successful, which may occur for any number of reasons known in the art.

After receiving the response 308, the base station 108 transmits a short data burst 310 including the information contained in the expedited application request packet 304 to the SU 112 by way of the common channel. This informs the SU 112 of the type of communication requested (e.g. a dispatch communication) and the initiator of the communication (e.g. SU 110). In response to receiving the short data burst 310, the SU 112 sends a short data burst 312 containing a response to the received expedited application request packet to the base station 108 using the common channel.

Since in this example, the base station 108 has failed to reserve channel resources for a traffic channel to handle the requested communication, upon receiving the response 312 to the expedited application request packet, the base station 108 marks the response to indicate that channel resources for the traffic channel have not been reserved. The base station 108 then sends the marked response 314 to the expedited application request packet to the network application server 102 by way of the network 104. In this manner, the network application server 102 knows that channel resources for a traffic channel between the base station 108 and the SU 112 have not been reserved.

Accordingly, the network application server 102 can take appropriate actions based on the fact that channel resources have not been reserved. Such appropriate actions may include informing the calling SU 110 of a reject call, or proceeding with the call if it is a group call where other SUs and corresponding channels are available for the group call, or proceeding with the group call and attempt a “late join” for the SU 112, or waiting for channel resources to become available for the SU 112.

An advantage of the wireless communications system 100 and associated method of notifying a network application server of the status of channel resource reservation is that “false positives” may be prevented or reduced. As discussed in the Background section, “false positives” occur when the network application server operates as if channel resources are available for a traffic channel between a base station and an SU. Such “false positives” lead to negative user experiences in that a user thinks it is sending a communication to the target SU, when in fact the user is not.

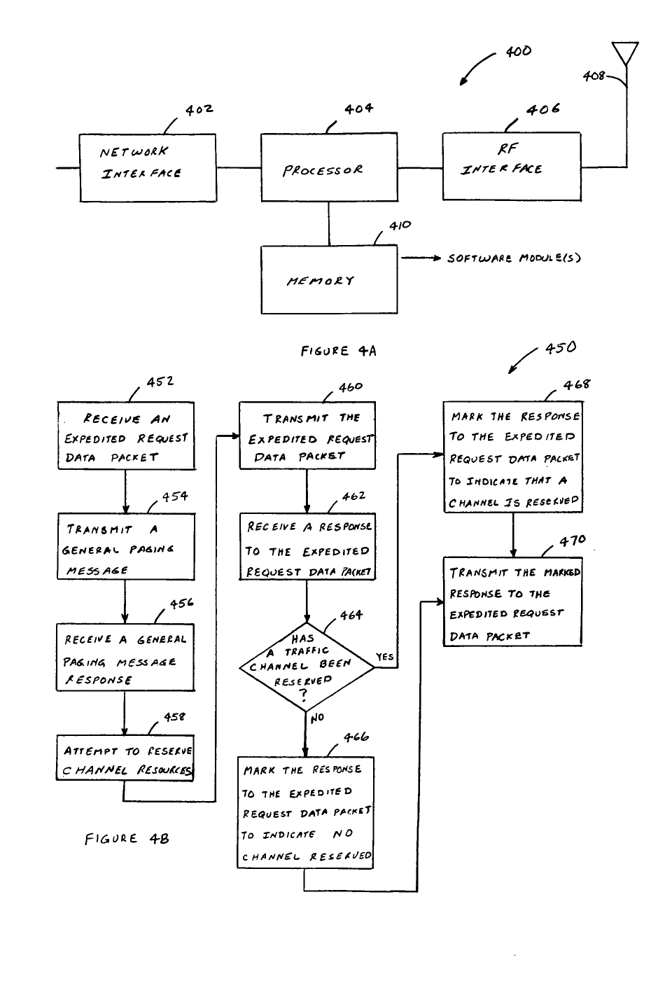

FIG. 4A illustrates a block diagram of an exemplary base station 400 in accordance with another embodiment of the invention. The base station 400 is an exemplary detailed version of the base stations 106 and 108 of the wireless communications system 100. In particular, the base station 400 comprises a network interface 402, a processor 404, an RF interface 406, an antenna 408, and a memory 410.

The network interface 402 provides the base station 400 an interface to the network 104 to receive communications from and send communications to the network application server 102 and other network devices. The processor 404 performs the various operations of the base station 400 as discussed with reference to FIG. 4B. The RF interface 406 including the antenna 408 provide the base station 400 an interface to the wireless medium to receive communications from and send communications to SUs, such as SU 112. The memory 410, serving generally as a computer readable medium, stores one or more software modules that control the processor 404 in performing its various operations. The operations implemented by the base station 400 are discussed as follows.

FIG. 4B illustrates a flow diagram of an exemplary method 450 implemented by the exemplary base station 400 in accordance with another embodiment of the invention. The method 450 begins with the processor 404 receiving an expedited application request packet from a network application server by way of the network interface 402 (block 452). In response to receiving the expedited application request packet, the processor 404 transmits a general paging message to a target SU via a paging channel facilitated by the RF interface 406 and the antenna 408 (block 454). After sending the general paging message, the processor 404 receives a response to the general paging message from the target SU via the paging channel facilitated by the RF interface 406 and the antenna 408 (block 456).

After receiving the response to the general paging message, the processor 404 attempts to reserve channel resources for a traffic channel to facilitate the requested communication to the target SU (block 458). In addition, the processor 404 transmits the expedited application request packet to the target SU via a common channel facilitated by the RF interface 406 and the antenna 408 (block 460). After sending the expedited application request packet, the processor 404 receives a response to the expedited application request packet via the common channel facilitated by the RF interface 406 and the antenna 408 (block 462).

The processor 404 then determines whether channel resources for a traffic channel has been reserved for the requested communication identified in the expedited application request packet (block 464). If the processor 404 determines that channel resources have not been reserved for the requested communication, the processor 404 marks the response to the expedited application request packet to indicate that channel resources are not available (block 466). Otherwise, if the processor 404 determines that channel resources for a traffic channel have been reserved for the requested communication, the processor 404 marks the response to the expedited application request packet to indicate that channel resources have been reserved (block 468). Once the response to the expedited application request packet has been appropriately marked, the processor 404 transmits the response to the network application server 102 by way of the network interface 402 (block 470).

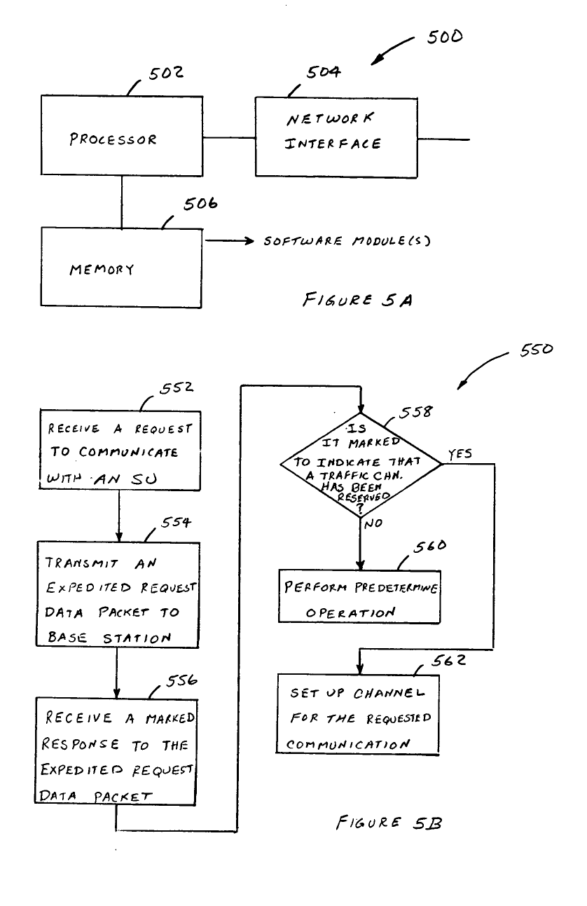

FIG. 5A illustrates a block diagram of an exemplary network application server 500 in accordance with an embodiment of the invention. The network application server 500 is an exemplary detailed version of the network application server 102 of the wireless communications system 100. In particular, the network application server 500 comprises a processor 502, a network interface 504, and a memory 506.

The processor 502 performs the various operations of the network application server 500 as discussed below with reference to FIG. 5B. The network interface 504 provides the network application server 500 an interface to the network 104 to receive communications from and send communications to base stations, SUs, and other network devices. The memory 506, serving generally as a computer readable medium, stores one or more software modules that control the processor 502 in performing its various operations. The operations implemented by the network application server 500 are discussed as follows.

FIG. 5B illustrates a flow diagram of an exemplary method 550 implemented by the exemplary network application server 500 in accordance with another embodiment of the invention. The method 550 begins by the processor 502 receiving a request from a calling entity to communicate with a target SU, by way of the network interface 504 (block 552). In response to the request, the processor 502 generates and transmits an expedited application request packet to the base station currently assigned to communicate with the target SU, by way of the network interface 504 (block 554).

After transmitting the expedited application request packet, the processor 502 receives the marked response to the expedited application request packet from the base station by way of the network interface 504 (block 556). After receiving the marked response, the processor 502 determines whether the marked response indicates whether channel resources for a traffic channel have been reserved to handle the requested communication with the SU (block 558). If the processor 502 determines that channel resources have been reserved, the processor 502 performs various operations to setup a channel for the requested communication (block 562).

On the other hand, if the processor 502 determines that channel resources for a traffic channel have not been reserved, the processor 502 may perform a number of predetermined operations (block 560). For example, the processor 502 may send a call reject message to the calling entity (e.g., the calling SU) by way of the network interface 504. The message may indicate that the call cannot be completed because channel resources could not be reserved. Alternatively, or in addition to, the processor 502 may perform various operations to setup channels for a group call for target SUs that are available for the call. Alternatively, or in addition to, the processor 502 may proceed with the group call as discussed, and further attempt a “late join” for the SU without channel resources (i.e. to re-page the SU in an attempt to join it in the group call). Alternatively, or in addition to, the processor 502 may wait for a further notification from the base station that channel resources are available and reserved (i.e. the base station queues the request for channel resources and informs the network application server when they become available).

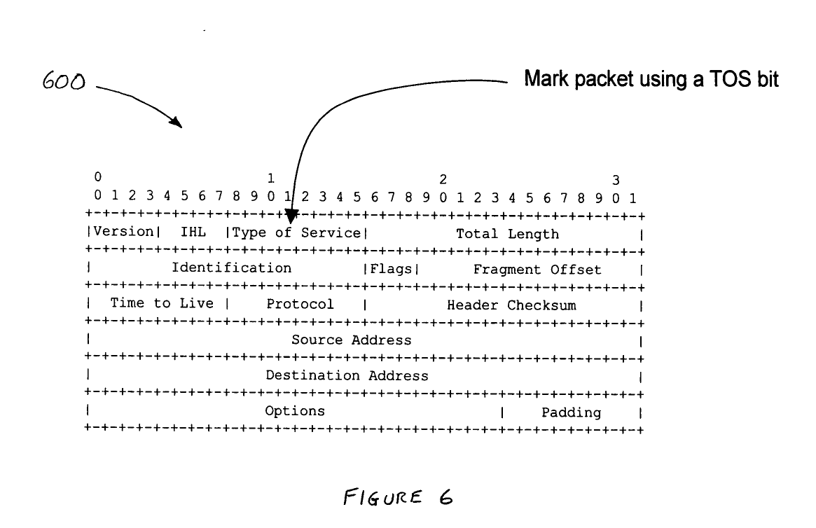

FIG. 6 illustrates a diagram of an exemplary packet header 600 in accordance with another embodiment of the invention. This packet header 600 is used herein to exemplify one way of marking a packet to inform the network application server as to whether the target base station was able to reserve channel resources for a traffic channel to communicate with a target SU. The packet header 600 is of the type used in Internet Protocol (IP) version 4. It shall be understood that other protocols and different versions of IP may be used.

The packet header 600 comprises various fields such as the version, IP header link (IHL), Type of Service (TOS), Total Length, Identification, Flags, Fragment Offset, Time to Live, Protocol, Header Checksum, Source Address, Destination Address, Options, and Padding. One way to mark the packet header 600 is to mark one or more bits in the TOS field to indicate whether the target base station was able to reserve channel resources for a traffic channel to communicate with a target SU. It shall be understood that other fields of the packet header 600 may be marked to indicate the same.

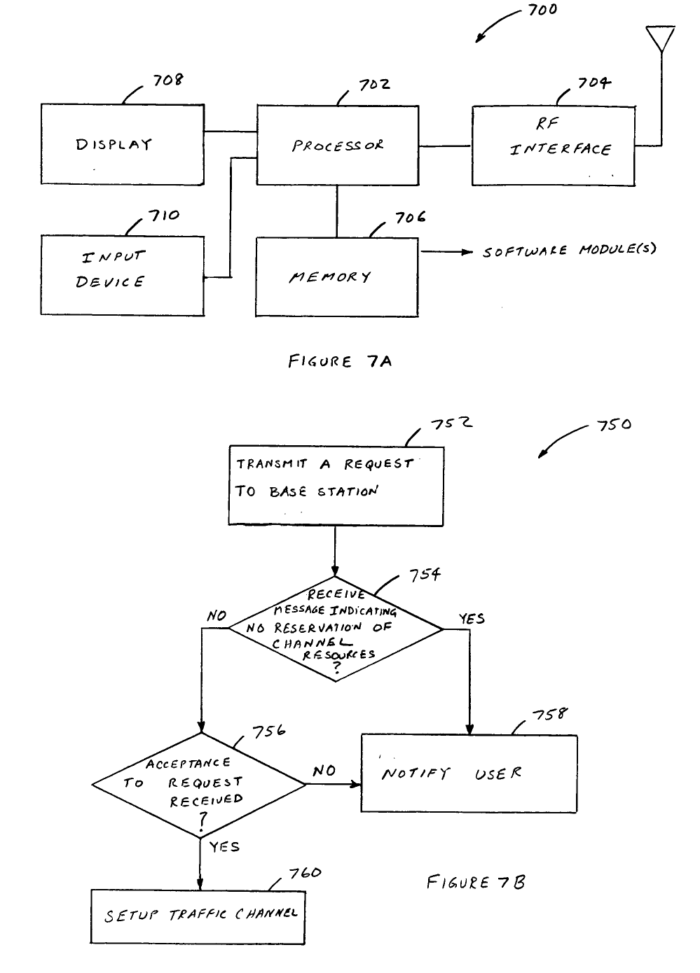

FIG. 7A illustrates a block diagram of an exemplary subscriber unit 700 in accordance with another embodiment of the invention. The subscriber unit 700 comprises a processor 702, an RF interface 704 including an antenna, a memory 706, a display 708, and an input device 710. The processor 702 performs the various operations of the subscriber unit 700 as discussed below with reference to FIG. 7B. In particular, the processor 702 sends an expedited request to the corresponding base station, assists in setting up a traffic channel if an acceptance response to request is received, and notifies the user or performs other operations if a notice is received that channel resources for the request cannot be reserved.

The RF interface 704 including the antenna provide an interface to the wireless medium for receiving communication from and sending communication to a wireless communication system by way of base stations. The display 708 provides a user with visual information. The input device 710 provides a user a manner to provide information to the subscriber unit 700. It shall be understood that the display 708 and input device 710 may be an integrated component, such as, for example, a touch-sensitive display screen. The memory 706, serving generally as a computer readable medium, stores one or more software modules for controlling the operations of the processor 702. The following provides a discussion of various operations performed by the subscriber unit 700.

FIG. 7B illustrates a flow diagram of an exemplary method 750 implemented by the subscriber unit 700 in accordance with another embodiment of the invention. According to the method 750, upon a user activating the input device 710 in order to send a request to communicate with a target SU via the wireless communications system, the processor 702 transmits a request to the corresponding base station by way of the RF interface 704 (block 752). After transmitting the request, the processor 702 determines whether it has received a notification from the wireless communications system that the target base station could not reserve channel resources for a traffic channel to communicate with the target SU (block 754).

If the processor 702 determines that it has received the notification indicating that channel resources cannot be reserved, the processor 702 may perform a number of predetermined operations, such as notifying the user via the display 708 or other notification device (block 758). Otherwise, the processor 702 determines whether it has received a message accepting the request (block 756). If the processor 702 receives such a message, the processor 702 communicates with the corresponding base station to setup a traffic channel (block 760). Otherwise, the processor 702 may perform a number of predetermined operations, such as notifying the user via the display 708 or other notification device (758).

While the invention has been described in connection with various embodiments, it will be understood that the invention is capable of further modifications. This application is intended to cover any variations, uses or adaptation of the invention following, in general, the principles of the invention, and including such departures from the present disclosure as come within the known and customary practice within the art to which the invention pertains.

1. A wireless communications system, comprising:
a network application server to transmit a request packet; and
a base station to:
receive said request packet from said network application server;
attempt to reserve channel resources for a traffic channel to communicate with a subscriber unit; and
notify said network application server of whether said channel resources have been reserved.

2. The wireless communications system of claim 1, wherein said base station is adapted to transmit said request packet to said subscriber unit by way of a wireless medium.

3. The wireless communications system of claim 2, wherein said base station is adapted to transmit said request packet to said subscriber unit using a common channel.

4. The wireless communications system of claim 2, wherein said base station is adapted to receive a response to said request packet from said subscriber unit by way of said wireless medium.

5. The wireless communications system of claim 4, wherein said base station is adapted to receive said response by way of a common channel.

6. The wireless communications system of claim 4, wherein said base station is adapted to notify said network application server by:
marking said response to indicate whether said channel resources have been reserved; and
sending said marked response to said network application server.

7. The wireless communications system of claim 6, wherein said base station is adapted to send said marked response to said network application server by way of a network.

8. The wireless communications system of claim 1, wherein said base station is adapted to transmit a paging message to said subscriber unit to cause said subscriber unit to exit a dormant mode.

9. The wireless communications system of claim 8, wherein said base station is adapted to transmit said paging message to said subscriber unit by way of a paging channel.

10. The wireless communications system of claim 8, wherein said base station is adapted to receive a response to said paging message from said subscriber unit.

11. The wireless communications system of claim 10, wherein said base station is adapted to receive said response by way of a paging channel.

12. The wireless communications system of claim 1, wherein said network application server is adapted to transmit said request packet in response to a communication request received from a calling entity.

13. The wireless communications system of claim 12, wherein said calling entity comprises a calling subscriber unit.

14. A method comprising:
receiving a request packet from a network application server;
attempting to reserve channel resources for a traffic channel to communicate with a subscriber unit; and
notifying said network application server of whether said channel resources have been reserved.

15. The method of claim 14, further comprising transmitting said request packet to said subscriber unit by way of a wireless medium.

16. The method of claim 15, wherein transmitting said request packet to said subscriber unit comprises using a common channel for transmitting said request packet.

17. The method of claim 15, further comprising receiving a response to said request packet from said subscriber unit by way of said wireless medium.

18. The method of claim 17, wherein receiving said response to said request packet from said subscriber unit comprises using a common channel for receiving said response.

19. The method of claim 17, wherein notifying said network application server comprises:
marking said response to indicate whether said channel resources have been reserved; and
sending said marked response to said network application server.

20. The method of claim 14, further comprising transmitting a paging message to said subscriber unit to cause said subscriber unit to exit a dormant mode.

21. The method of claim 20, further comprising receiving a response to said paging message from said subscriber unit.

22. A base station comprising:
a network interface;
a radio frequency (RF) interface; and
a processor to:
receive a request packet from a network application server by way of said network interface;
attempt to reserve channel resources for a traffic channel to communicate with a subscriber unit; and
notify said network application server of whether said channel resources have been reserved.

23. The base station of claim 22, wherein said processor is adapted to transmit said request packet to said subscriber unit by way of said RF interface.

24. The base station of claim 23, wherein said processor is adapted to receive a response to said request packet from said subscriber unit by way of said RF interface.

25. The base station of claim 24, wherein said processor is adapted to notify said network application server by:
marking said response to indicate whether said channel resources have been reserved; and
sending said marked response to said network application server by way of said network interface.

26. The base station of claim 22, wherein said processor is adapted to transmit a paging message to said subscriber unit by way of said RF interface.

27. The base station of claim 26, wherein said processor is adapted to receive a response to said paging message from said subscriber unit by way of said RF interface.

28. A computer readable medium including one or more software modules to control a processor to:
receive a request packet from a network application server by way of a network interface;
attempt to reserve channel resources for a traffic channel to communicate with a subscriber unit; and
notify said network application server of whether said channel resources have been reserved.

29. The computer readable medium of claim 28, wherein said one or more software modules to control said processor to transmit said request packet to said subscriber unit by way of a radio frequency (RF) interface.

30. The computer readable medium of claim 29, wherein said one or more software modules to control said processor to receive a response to said request packet from said subscriber unit by way of said RF interface.

31. The computer readable medium of claim 30, wherein said one or more software module to control said processor to notify said network application server by:
marking said response to indicate whether said channel resources have been reserved; and
sending said marked response to said network application server by way of said network interface.

32. The computer readable medium of claim 28, wherein said one or more software modules to control said processor to transmit a paging message to said subscriber unit by way of an RF interface.

33. The computer readable medium of claim 32, wherein said one or more software modules to control said processor to receive a response to said paging message from said subscriber unit by way of said RF interface.

34. A method comprising:
transmitting a request packet to a base station; and
receiving a notification from said base station as to whether channel resources for a traffic channel to communicate with a subscriber unit have been reserved.

35. The method of claim 34, further comprising performing a predetermined operation based on what said notification indicates about said reservation of said channel resources.

36. The method of claim 35, wherein performing said predetermined operation comprises setting up a communication channel to communicate with said subscriber unit if said notification indicates that said channel resources have been reserved.

37. The method of claim 35, wherein performing said predetermined operation comprises informing an initiator unit that communication with said subscriber unit is not available if said notification indicates that said channel resources have not been reserved.

38. The method of claim 35, wherein performing said predetermined operation comprises setting up communication channels for a group call for other available subscriber units.

39. The method of claim 35, wherein performing said predetermined operation comprises:
setting up communication channels for a group call for other available subscriber units; and
attempting to join said subscriber unit into said group call.

40. The method of claim 35, wherein performing said predetermined operation in the case that said notification indicates that said channel resources have not been reserved, comprises:
receiving another notification from said base station indicating that said channel resources have been reserved; and
setting up a communication channel to communicate with said subscriber unit.

41. A network application server comprising:
a network interface; and
a processor to:
transmit a request packet to a base station by way of said network interface; and
receive a notification from said base station as to whether channel resources for a traffic channel to communicate with a subscriber unit have been reserved, wherein said notification is received by way of said network interface.

42. The network application server of claim 41, wherein said processor is adapted to perform a predetermined operation based on what said notification indicates about said reservation of said channel resources.

43. The network application server of claim 42, wherein said predetermined operation comprises setting up a communication channel to communicate with said subscriber unit if said notification indicates that said channel resources have been reserved.

44. The network application server of claim 42, wherein performing said predetermined operation comprises sending a message to an initiator unit that communication with said subscriber unit is not available if said notification indicates that said channel resources have not been reserved, wherein said message is sent by way of said network interface.

45. The network application server of claim 42, wherein performing said predetermined operation comprises setting up communication channels for a group call for other available subscriber units.

46. The network application server of claim 42, wherein performing said predetermined operation comprises:
setting up communication channels for a group call for other available subscriber units; and
attempting to join said subscriber unit into said group call.

47. The network application server of claim 42, wherein performing said predetermined operation in the case that said notification indicates that said channel resources have not been reserved, comprises:
receiving another notification from said base station indicating that said channel resources have been reserved; and
setting up a communication channel to communicate with said subscriber unit.

48. A computer readable medium including one or more software modules to control a processor to:
transmit a request packet to a base station by way of a network interface; and
receive a notification from said base station as to whether channel resources for a traffic channel to communicate with a subscriber unit have been reserved, wherein said notification is received by way of said network interface.

49. The computer readable medium of claim 48, wherein said one or more software modules to control said processor to perform a predetermined operation based on what said notification indicates about said reservation of said channel resources.

50. The computer readable medium of claim 49, wherein said predetermined operation comprises setting up a communication channel to communicate with said subscriber unit if said notification indicates that said channel resources have been reserved.

51. The computer readable medium of claim 49, wherein performing said predetermined operation comprises sending a message to an initiator unit that communication with said subscriber unit is not available if said notification indicates that said channel resources have not been reserved, wherein said message is sent by way of said network interface.

52. The computer readable medium of claim 49, wherein performing said predetermined operation comprises setting up communication channels for a group call for other available subscriber units.

53. The computer readable medium of claim 49, wherein performing said predetermined operation comprises:
setting up communication channels for a group call for other available subscriber units; and
attempting to join said subscriber unit into said group call.

54. The computer readable medium of claim 49, wherein performing said predetermined operation in the case that said notification indicates that said channel resources have not been reserved, comprises:
receiving another notification from said base station indicating that said channel resources have been reserved; and
setting up a communication channel to communicate with said subscriber unit.

55. A subscriber unit, comprising:
an RF interface; and
a processor to:
transmit a request to a wireless communications system by way of said RF interface, wherein said request identifies a target subscriber unit; and
receive a notification by way of said RF interface indicating that channel resources for a traffic channel between said target subscriber unit and a target base station could not be reserved.

56. A method, comprising:
transmitting a request to a wireless communications system by way of an RF interface, wherein said request identifies a target subscriber unit; and
receiving a notification by way of said RF interface indicating that channel resources for a traffic channel between said target subscriber unit and a target base station could not be reserved.

57. A computer readable medium comprising one or more software modules to control a processor to:
transmit a request to a wireless communications system by way of an RF interface, wherein said request identifies a target subscriber unit; and
receive a notification by way of said RF interface indicating that channel resources for a traffic channel between said target subscriber unit and a target base station could not be reserved.
